(19) United States
(12) Patent Application Publication
(10) Pub. No.: US 2026/0055884 A1
(43) Pub. Date: Feb. 26, 2026

(54) LIGHT STRING

(71) Applicant: TAIZHOU SANBRITE TRADING COMPANY LIMITED, Taizhou City (CN)

(72) Inventors: Ke Sun, Taizhou City (CN); Yunbing Weng, Taizhou City (CN); Xueli Chen, Taizhou City (CN)

(21) Appl. No.: 19/371,821

(22) Filed: Oct. 28, 2025

(51) Int. Cl. F21V 23/06; F21S 4/10; F21V 3/02; F21V 17/16; F21V 23/00; F21Y 115/10

(52) U.S. Cl. CPC F21V 23/06; F21S 4/10; F21V 3/02; F21V 17/164; F21V 23/001; F21Y 2115/10

(57) ABSTRACT

A light string includes a wire portion and a plurality of lamp interfaces sequentially and electrically connected in series with the wire portion, the light string further includes light-emitting portions pluggably connected with the lamp interfaces. The light-emitting portion comprises a light-emitting element, a lampshade located outside the light-emitting element, and a plug-in connector connected with the lampshade, wherein the plug-in connector is provided with a first conductive member and a second conductive member, the first conductive member and the second conductive member being capable of electrically connecting the light-emitting element with the wire portion when the plug-in connector is inserted into the lamp interface. By adopting a plug-in connection method between the light-emitting portion and the lamp interface, the present disclosure facilitates replacement for users, greatly reduces the use cost, and avoids waste of the light string.

### TECHNICAL FIELD

The present disclosure relates to the technical field of lighting devices, in particular to a light string.

### BACKGROUND

A light string consists of several light beads strung along a long wire, serving as a decorative item or an atmosphere-enhancing product for both indoor and outdoor use. However, the light-emitting elements in existing light strings are commonly connected to the wires through non-separable methods such as riveting or welding. Consequently, when the internal wiring of the light string is arranged in a series configuration, the failure of a single light-emitting element will render the entire light string inoperative, resulting in significant waste.

Although there are already light strings that adopt traditional bulb structures for the light beads, with bulbs screwed into lamp holders for easy replacement, this approach still brings inconvenience during each installation. Moreover, such bulbs mostly have a single shape, and offer relatively few options in terms of brightness and emitted light colors. Additionally, in existing light strings, each light-emitting element typically contains only a single LED. Therefore, an additional rectifier unit must be added at the plug of the lamp to rectify the alternating current and achieve a flicker-free LED lighting effect.

### SUMMARY

To overcome the above drawbacks, an objective of the disclosure is to provide a light string, which includes a wire portion and a plurality of lamp interfaces sequentially and electrically connected in series with the wire portion, the light string further includes light-emitting portions pluggably connected with the lamp interfaces. The light-emitting portion includes a light-emitting element, a lampshade located outside the light-emitting element, and a plug-in connector connected with the lampshade, wherein the plug-in connector is provided with a first conductive member and a second conductive member, the first conductive member and the second conductive member being capable of electrically connecting the light-emitting element with the wire portion when the plug-in connector is inserted into the lamp interface.

The present disclosure has the following beneficial effects:
(1) The present disclosure achieves the disassembly or installation of the light-emitting portion and the main body of the light string through a plug-in connection method between the light-emitting portion and the lamp interface. Even if one light-emitting portion is damaged, users can easily replace it while keeping the entire light string still functional. This significantly reduces use costs and prevents the waste of the light string.
(2) This application enables easy separation or connection of the light-emitting portion and the lamp interface through simple plugging and unplugging actions, without adopting the threaded connection method used in the prior art. Moreover, it achieves electrical connection between the light-emitting element and the wire portion without requiring any professional tools, providing significant convenience for both the assembly production and use of the light string.
(3) In this application, the light-emitting element, the lampshade, and the plug-in connector are integrated as a whole light-emitting portion, which can be entirely replaced when the light-emitting element is damaged. Consequently, the light-emitting element can adopt a PCB-based design, offering higher brightness, diverse color options, and a longer service life.

Furthermore, a first conductive plate and a second conductive plate are arranged inside the lamp interface, and the first conductive plate is capable of abutting against the first conductive member to achieve electrical connection, the second conductive plate is capable of abutting against the second conductive member to achieve electrical connection when the plug-in connector is inserted into the lamp interface. Therefore, through the cooperation between the first conductive plate and the first conductive member, as well as the second conductive plate and the second conductive member, electrical connection between the light-emitting element and the wire portion can be easily achieved when the light-emitting portion is plugged into the lamp interface. The plugging action is effortless, which facilitates production and processing, and also brings convenience to end-users in usage and operation without the need for auxiliary tools.

Furthermore, the plug-in connector further includes an electrical isolation portion, and the electrical isolation portion includes a conductive member isolation region for isolating the first conductive member and the second conductive member from each other.

Furthermore, a first cavity and a second cavity for allowing the first conductive member and the second conductive member to pass through are respectively arranged on two opposite outer sides of the conductive member isolation region, and outer sidewalls of the first cavity and the second cavity, away from the conductive member isolation region, are a first limiting sidewall and a second limiting sidewall, respectively, the first limiting sidewall and the second limiting sidewall being gradually inclined away from the conductive member isolation region along a direction towards the light-emitting element. Therefore, after the first conductive member and the second conductive member pass through the first cavity and the second cavity, their ends are then bent toward the side close to the light-emitting element, and further abut against the outer sidewalls of the first cavity and the second cavity that are away from the conductive member isolation region. Since the first limiting sidewall and the second limiting sidewall of the first cavity and the second cavity are arranged obliquely, when the plug-in connector is inserted into the lamp interface, the tail ends of the first conductive member and the second conductive member are respectively inclined toward the directions closer to the first conductive plate and the second conductive plate under the guidance of the first limiting sidewall and the second limiting sidewall. Thus, the effect of sufficient abutment between the first conductive plate and the first conductive member as well as between the second conductive plate and the second conductive member can be achieved merely through the clever arrangement of the first limiting sidewall and the second limiting sidewall.

Furthermore, a distance between the surface of the end, close to the light-emitting element, of the first conductive plate, which is close to the first limiting sidewall and the first limiting sidewall is smaller than the diameter of a tail end of the first conductive member; and a distance between the surface of the end, close to the light-emitting element, of the second conductive plate, which is close to the second limiting sidewall and the second limiting sidewall is smaller than the diameter of a tail end of the second conductive member. Thus, stable electrical connection between the first conductive plate and the first conductive member as well as between the second conductive plate and the second conductive member can be ensured.

Furthermore, a notch portion is arranged on the wire portion at a region corresponding to the lamp interface, and the wire portion forms two wire ends at the notch portion for electrical connection with the light-emitting element, the two wire ends being electrically connected with the first conductive plate and the second conductive plate respectively.

Furthermore, a first connection end and a second connection end are respectively arranged on wire protective layers at tail ends of the two wire ends, the first connection end is connected with the first conductive plate through a wire clamping member and the second connection end is connected with the second conductive plate through the wire clamping member, so that internal conductors of the wire ends exposed outside the protective layers are bound by the wire clamping members, and the tail ends of the internal conductors are brought into contact with the first conductive plate and the second conductive plate respectively. This further enables electrical connection with the two wire ends corresponding to the notch portion, thereby allowing the light-emitting element to be connected in series to the wire portion.

Furthermore, the electrical isolation portion further includes a connection end isolation region for isolating the first connection end and the second connection end from each other.

Furthermore, the side of the connection end isolation region close to the wire end to which the notch portion corresponds is provided with a limiting groove recessed away from the wire portion. Therefore, when the plug-in connector is inserted into the lamp interface, it can achieve a more stable matching effect between the wire end and the connection end isolation region, and can also play a better guiding role for the direction in which the plug-in connector is inserted into the lamp interface, making the assembly and disassembly of the plug-in connector smoother.

Furthermore, the plug-in connector further includes a connection cap arranged close to the lampshade, an installation opening for installing the light-emitting element is arranged in the connection cap, the first cavity and the second cavity communicate with the installation opening, the first conductive member passes through the first cavity to connect with the light-emitting element, and the second conductive member passes through the second cavity to connect with the light-emitting element.

Furthermore, at least one snap-fit protrusion is arranged on the connection cap, a snap-fit groove arranged along the circumferential direction of the lamp interface is arranged on an inner wall of the lamp interface in a region corresponding to the snap-fit protrusion, and the snap-fit protrusion is provided a guide surface that is gradually inclined toward the central axis of the connection cap in a direction away from the lampshade. Thus, it facilitates inserting the plug-in connector into the lamp interface.

Furthermore, the lamp interface includes an outer interface provided with a bent region that shrinks toward the central axis of the outer interface, the bent region being mutually abuttable with a surface of the connection cap away from the light-emitting element.

Furthermore, the lamp interface further includes an inner interface arranged inside the outer interface, the inner interface is provided with inner abutting walls facing the first conductive plate and the second conductive plate, the inner abutting walls are arranged opposite to the first limiting sidewall and the second limiting sidewall, after the plug-in connector is inserted into the lamp interface, the inner abutting walls are capable of abutting the first conductive plate and the second conductive plate against the first limiting sidewall and second limiting sidewall, respectively, a first stepped surface that protrudes outward away from the central axis of the plug-in connector is provided on the side, close to the light-emitting element, of the first limiting sidewall and the second limiting sidewall of the plug-in connector, and a second stepped surface capable of cooperating with the first stepped surface is provided on an end of the inner abutting wall close to the light-emitting element. Thus, after the plug-in connector is inserted into the lamp interface, the first stepped surface and the second stepped surface can abut against each other in partial regions. Together with the inner abutting walls and the limiting sidewalls, they jointly form an accommodating space. This space ensures that the first conductive member and the first conductive plate abut against each other and achieve electrical connection, and the second conductive member and the second conductive plate abut against each other and achieve electrical connection.

Furthermore, the surface of the connection cap away from the light-emitting element is further provided with at least one first limiting protrusion matching with the inner interface and at least one second limiting protrusion matching with the inner interface.

Furthermore, the first limiting protrusion and the second limiting protrusion each protrude away from the upper surface of the connection cap, and extend in a direction away from the central axis of the plug-in connector, the first limiting protrusion extending a greater distance than the second limiting protrusion in the direction away from the central axis of the plug-in connector, and the first limiting protrusion also having a greater height than the second limiting protrusion when protruding away from the connection cap. Thus, the lengths of the regions of the inner interface corresponding to a first notch and a second notch that extend toward the light-emitting element form a staggered effect, and accordingly a more stable connection effect with the plug-in connector is formed.

Furthermore, the inner wall of the lamp interface is further provided with a guide rim protruding towards the central axis of the lamp interface, the guide rim being arranged in a direction of mutual plugging of the plug-in connector and the lamp interface, and a guide groove capable of matching with the guide rim is arranged on the outer surface of the connection cap.

Furthermore, a first groove for the plug-in connector to snap into is provided on the surface of the lamp interface that is away from the light-emitting element, a second groove that is arranged perpendicularly to and in communication with the first groove is further included, the second groove being arranged along the length direction of the light string, and the two wire ends corresponding to the notch portion are respectively arranged at the mutually distant ends of the second groove. Thus, when the plug-in connector is inserted into the first groove, the isolation region of the plug-in connector can be just positioned between the two wire ends.

Furthermore, a male joint and a female joint are provided at a head end and a tail end of the light string, respectively. Thus, a plurality of light strings can be electrically connected in series as needed.

Furthermore, the shape of the light-emitting element is selected from at least one of the following shapes: inverted triangle, V-shape or W-shape.

Furthermore, the light-emitting element is a PCB-based light-emitting element, a plurality of parallel LED beads are arranged on the light-emitting element, and positive and negative electrodes of any two adjacent beads are arranged in a staggered manner. Thus, in the present application, a plurality of parallel-connected LEDs are arranged on the light-emitting element, and the positive and negative electrodes of the LEDs are distributed in opposite directions according to their odd-even positions. Therefore, even when powered by an alternating current, the human eye cannot perceive the flickering of the LEDs. This eliminates the need for a rectifier unit and optimizes the manufacturing cost.

The present disclosure changes the common linear shape of PCB-based light-emitting elements in the prior art, and instead configures them into inverted triangular, V-shaped, or W-shaped structures. This makes the light string have more diverse shapes and a higher aesthetic appeal.

### BRIEF DESCRIPTION OF DRAWINGS

FIG. 1 is a three-dimensional structural schematic diagram of the light string according to an embodiment of the present disclosure, and the wavy lines represent an omitted repeated view of the middle part;

FIG. 2 is a three-dimensional structural schematic diagram of the light-emitting portion according to an embodiment of the present disclosure;

FIG. 3 is a structural schematic diagram of the light-emitting portion without the lampshade according to an embodiment of the present disclosure;

FIG. 4 is a schematic diagram of the connection relationship between the light-emitting portion, the first conductive member, and the second conductive member according to an embodiment of the present disclosure;

FIG. 5 is a structural schematic diagram of the notch portion of the wire portion according to an embodiment of the present disclosure;

FIG. 6 is a schematic diagram of the connection relationship between the electrical isolation portion and the wire portion according to an embodiment of the present disclosure;

FIG. 7 is a schematic diagram of the connection relationship between the plug-in connector of the light-emitting portion and the connection cap according to an embodiment of the present disclosure;

FIG. 8 is a three-dimensional structural schematic diagram of the first groove and the second groove of the lamp interface according to an embodiment of the present disclosure;

FIG. 9 is a three-dimensional structural schematic diagram of the lamp interface according to an embodiment of the present disclosure; and

FIG. 10 is a three-dimensional structural schematic diagram of the lamp interface without the first conductive plate and the second conductive plate according to an embodiment of the present disclosure.

In the figures:
1, wire portion; 11, notch portion; 111, wire end;
2, lamp interface; 211, first conductive plate; 212, second conductive plate; 221, first connection end; 222, second connection end;
23, wire clamping member; 241, first groove; 242, second groove; 25, snap-fit groove; 26, guide rim; 27, outer interface; 271, bent region;
28, inner interface; 281, inner abutting wall; 2811, second stepped surface; 282, first notch; 283, second notch;
3, light-emitting portion;
31, plug-in connector; 311, first conductive member; 312, second conductive member; 32, light-emitting element; 33, lampshade;
313, electrical isolation portion; 3131, conductive member isolation region; 3132, connection end isolation region; 31321, limiting groove;
351, first cavity; 3511, first limiting sidewall;
352, second cavity; 3521, second limiting sidewall;
36, connection cap;
361, installation opening;
362, snap-fit protrusion; 3621, guide surface;
363, guide groove; 364, first limiting protrusion; 365, second limiting protrusion;
37, first stepped surface;
4, male joint;
5, female joint.

### DESCRIPTION OF THE EMBODIMENTS

The following detailed description of the preferred embodiments of the present disclosure will be made with reference to the accompanying drawings so that the advantages and features of the present disclosure can be more readily understood by those skilled in the art, and thus the scope of the present disclosure will be more clearly and clearly defined.

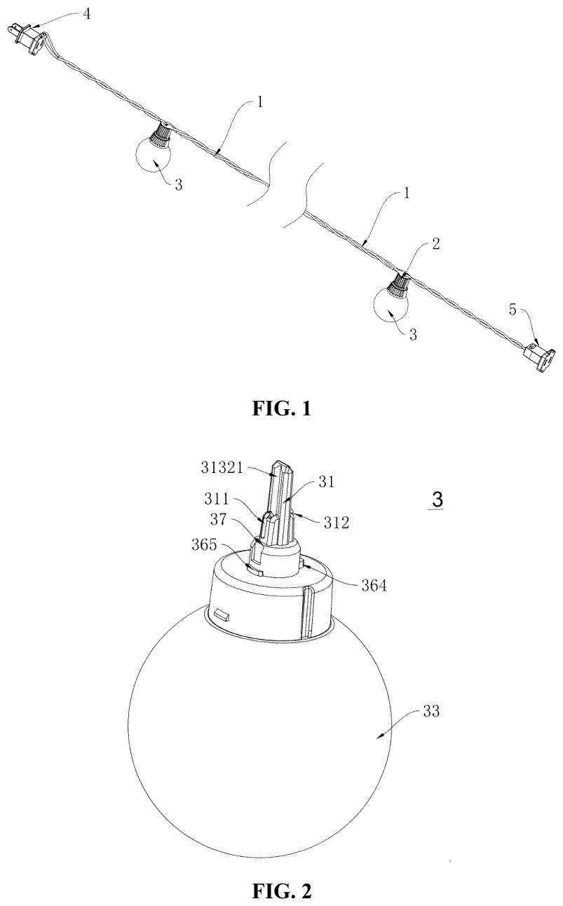

As shown in FIG. 1, a light string according to the present disclosure includes a wire portion 1 and a plurality of lamp interfaces 2 sequentially and electrically connected in series with the wire portion 1. The light string further includes light-emitting portions 3 pluggably connected with the lamp interfaces 2.

As shown in FIG. 2, the light-emitting portion 3 includes a plug-in connector 31 connected with a lampshade 33, a light-emitting element 32, and the lampshade 33 located outside the light-emitting element 32. The plug-in connector 31 is provided with a first conductive member 311 and a second conductive member 312 electrically connected with the light-emitting element 32, the first conductive member 311 and the second conductive member 312 being capable of electrically connecting the light-emitting element 32 with the wire portion 1 when the plug-in connector 31 of the light-emitting portion 3 is inserted into the lamp interface 2. Thus, it is achieved that merely through the plug-in connection between the light-emitting portion 3 and the lamp interface 2, the disassembly or installation of the light-emitting portion 3 and the main body of the light string can be realized. Moreover, only through simple plugging and unplugging actions, without the need for any tools, the electrical connection between the light-emitting element 32 and the wire portion 1 can be easily achieved.

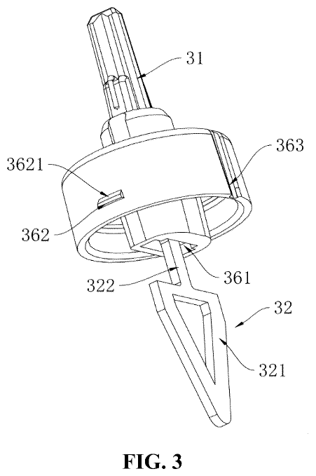

As shown in FIG. 3, in some embodiments, the light-emitting element 32 may be in shapes such as an inverted triangle, a V-shape, or a W-shape. The shapes of the respective light-emitting elements 32 in the same light string may be the same or different. The shape of the light-emitting element 32 of the present application can be obtained by directly processing the existing PCB-based linear light-emitting element 32. Correspondingly, the positive electrode and the negative electrode of the light-emitting element 32 are connected with the first conductive member 311 and the second conductive member 312 respectively.

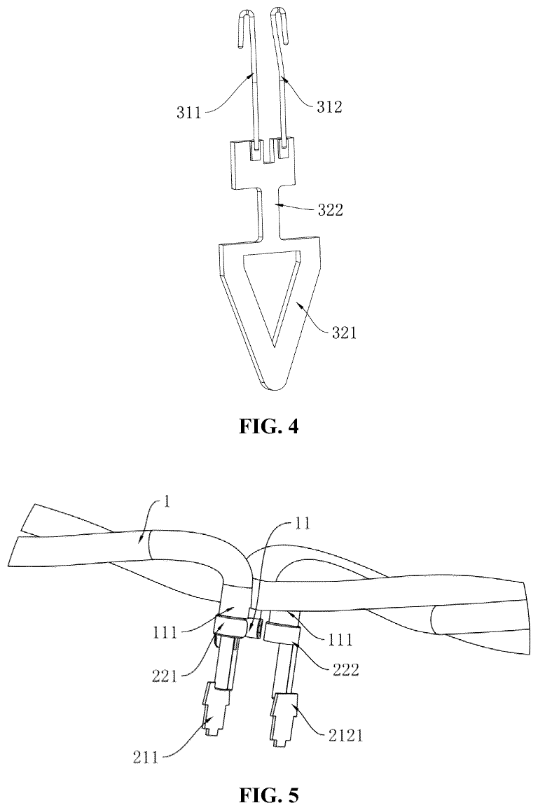

As shown in FIG. 4, in some embodiments, the light-emitting element 32 includes a light-emitting region 321 and an electrical connection region 322. Both the positive electrode and the negative electrode of the light-emitting element 32 are disposed in the electrical connection region 322; for example, this can be achieved by arranging the circuits on the PCB such that the positive electrode and the negative electrode are arranged in parallel and at an interval in the electrical connection region 322. The light-emitting region 321 of the light-emitting element 32 is correspondingly configured into shapes such as the aforementioned inverted triangle, V-shape, or W-shape, and the electrical connection region 322 is roughly located in the middle region of the light-emitting region 321 near the end of the electrical connection region 322.

In some embodiments, a plurality of parallel-connected LED beads are arranged on each light-emitting element 32, and the positive and negative electrodes of any two adjacent LED beads are arranged in a staggered manner. For example, the positive electrode of the first LED and the negative electrode of the second LED are connected in parallel, then connected in parallel with the positive electrode of the third LED, and so on. Thus, through the arrangement of the light-emitting element 32 in this form, even when powered by an alternating current, there is no need to install a rectifier unit, and the human eye cannot perceive the flickering of the LEDs, thereby optimizing the manufacturing cost.

In some embodiments, the light-emitting element, the lampshade, and the plug-in connector can be integrated as a whole through adhesion, welding, or snap-fitting. This integration facilitates easier operation when inserting or removing the light-emitting portion 3 from the lamp interface 2.

In some embodiments, the lampshade 33 is in the shape of a hollow geometric body (such as a hollow sphere, a hollow olive, a hollow cube, or a hollow cuboid), or a hollow cartoon shape or a hollow animal shape.

In some embodiments, a male joint 4 and a female joint 5 are respectively provided at the head end and the tail end of the light string. Thus, a plurality of light strings can be connected in series as needed.

As shown in FIG. 5, in some embodiments, a first conductive plate 211 and a second conductive plate 212 are arranged inside the lamp interface 2, and the first conductive plate 211 is capable of abutting against the first conductive member 311 to achieve electrical connection, the second conductive plate 212 is capable of abutting against the second conductive member 312 to achieve electrical connection when the plug-in connector 31 is inserted into the lamp interface 2. Therefore, through the cooperation between the first conductive plate 211 and the first conductive member 311, as well as the second conductive plate 212 and the second conductive member 312, electrical connection between the light-emitting element 32 and the wire portion 1 can be easily achieved when the light-emitting portion 3 is plugged into the lamp interface 2. The plugging action is effortless, which facilitates production and processing, and also brings convenience to end-users in usage and operation without the need for auxiliary tools.

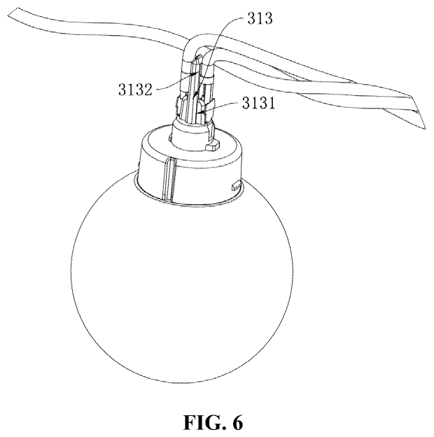

As shown in FIG. 6, in some embodiments, the plug-in connector 31 further includes an electrical isolation portion 313. The electrical isolation portion 313 includes a conductive member isolation region 3131, which is used to isolate the first conductive member 311 and the second conductive member 312 from each other and prevent mutual electrical interference. The conductive member isolation region 3131 is located between the first conductive member 311 and the second conductive member 312 and is made of an insulating material.

In some embodiments, on one outer side of the conductive member isolation region 3131, the plug-in connection 31 further includes a first cavity 351 for allowing the first conductive member 311 to pass through, and an outer sidewall of the first cavity 351, away from the conductive member isolation region 3131, is a first limiting sidewall 3511, the first limiting sidewall 3511 being gradually inclined away from the conductive member isolation region 3131 along a direction towards the light-emitting element 32. After the first conductive member 311 passes through the first cavity 351, the tail end is then bent toward the side close to the light-emitting element 32, and further abuts against the outer sidewall of the first cavity 351 that is away from the conductive member isolation region 3131. Since the first limiting sidewall 3511 of the first cavity 351 is arranged obliquely, when the plug-in connector 31 is inserted into the lamp interface 2, the end of the first conductive member 311 is inclined toward the direction closer to the first conductive plate 211 under the guidance of the first limiting sidewall 3511. Thus, the effect of sufficient abutment between the first conductive plate 211 and the first conductive member 311 can be achieved merely through the clever arrangement of the first limiting sidewall 3511. In some embodiments, a distance between the surface of the end, close to the light-emitting element, of the first conductive plate 211, which is close to the first limiting sidewall 3511 and the first limiting sidewall 3511 is smaller than the diameter of a tail end of the first conductive member 311. Thus, it can achieve a more stable interference abutment effect between the region of the first conductive plate 211 near one end of the light-emitting element 32 and the first conductive member 311, ensuring a stable electrical connection between the first conductive plate 211 and the first conductive member 311.

In some embodiments, the outer surfaces of the first limiting sidewall 3511 and the second limiting sidewall 3521 are smooth. Therefore, there is no need to provide any limiting grooves or similar structures thereon. Even if the tail end of the first conductive member 311 is twisted or inclined, due to the inclined arrangement of the first limiting sidewall 3511, it can still ensure sufficient contact and electrical connection between the first conductive member 311 and the first conductive plate 211, as well as sufficient contact and electrical connection between the second conductive member 312 and the second conductive plate 212.

In some embodiments, the plug-in connector further includes a second cavity 352, which is symmetrically arranged relative to the conductive member isolation region 3131 with the first cavity 351. The second cavity 352 is used for the second conductive member 312 to pass through and for the tail end thereof to be bent toward the side close to the light-emitting element 32. Correspondingly, the sidewall of the second cavity 352 away from the conductive member isolation region 3131 is the second limiting sidewall 3521, the second limiting sidewall 3512 being gradually inclined away from the conductive member isolation region 3131 along a direction towards the light-emitting element 32.

In some embodiments, a notch portion 11 is provided on the wire portion 1 in a region corresponding to the lamp interface 2 (FIG. 5), the guide portion passes through the notch portion 11, and there is one wire interrupted therein and two wire ends 111 are formed in the notch portion 11 for electrical connection with the light-emitting element 32. The inner conductors (not shown in the figure) of the tail ends of the wire ends 111 are exposed outside the wire protective layers. A first connection end 221 and a second connection end 222 are respectively provided on the wire protective layers at the tail ends of the two wire ends 111. The first connection end 221 is connected with the first conductive plate 211 through a wire clamping member 23 and the second connection end 222 is connected with the second conductive plate 212 through the wire clamping member 23. Correspondingly, the conductors of the wire ends 111 exposed outside the protective layers are bound by the wire clamping members 23, and the tail ends of the inner conductors are brought into contact with the first conductive plate 211 and the second conductive plate 212 respectively. This further enables electrical connection with the two wire ends 111 corresponding to the notch portion 11, thereby allowing the light-emitting element 32 to be connected in series to the wire portion 1. In some embodiments, the wire portion 1 is formed by hinging three wires. By connecting the first conductive plate 211 with one wire end 111 of an interrupted wire and the second conductive plate 212 with the other wire end 111 of the same wire, when the light-emitting portion 3 is inserted into the lamp interface 2, the effect of connecting the light-emitting element 32 in series with the entire light string can be achieved.

To prevent the two wire ends 111 corresponding to the notch portion 11 from touching each other and causing a short circuit, the electrical isolation portion 313 further includes a connection end isolation region 3132 for isolating the first connection end 221 and the second connection end 222 from each other (referring to FIG. 6).

In some embodiments, the connection end isolation region 3132 is made of a non-conductive material, and the side of the connection end isolation region 3132 close to the wire end 111 to which the notch portion 11 corresponds is provided with a limiting groove 31321 recessed away from the wire portion 1 (FIG. 2). Therefore, when the plug-in connector 31 is inserted into the lamp interface 2, it can achieve a more stable matching effect between the wire end 111 and the connection end isolation region 3132, and can also play a better guiding role for the direction in which the plug-in connector 31 is inserted into the lamp interface 2, making the assembly and disassembly of the plug-in connector 31 smoother.

As shown in FIG. 8, in some embodiments, a first groove 241 for the plug-in connector 31 to snap into is provided on the surface of a top wall of the lamp interface that is away from the light-emitting element 32, a second groove 242 that is arranged perpendicularly to and in communication with the first groove 241 is further included, the second groove 242 being arranged along the length direction of the light string, and the two wire ends 111 corresponding to the notch portion 11 are respectively arranged at the mutually distant ends of the second groove 242. Thus, an arrangement is formed in which the isolation region of the plug-in connector 31 is disposed in the middle region between the two wire ends 111.

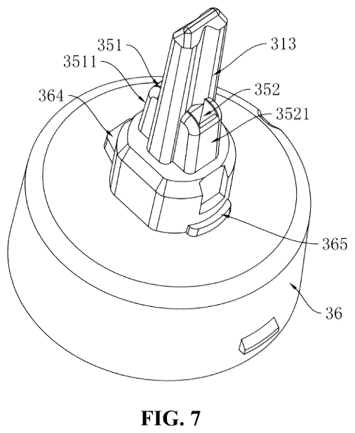

In some embodiments, the plug-in connector 31 further includes a connection cap 36 arranged close to the lampshade 33 (FIG. 7), an installation opening 361 for installing the light-emitting element 32 is arranged in the connection cap 36 (FIG. 3), the first cavity 351 and the second cavity 352 communicate with the installation opening 361, the first conductive member 311 passes through the first cavity 351 to connect with the light-emitting element 32, and the second conductive member 312 passes through the second cavity 352 to connect with the light-emitting element 32.

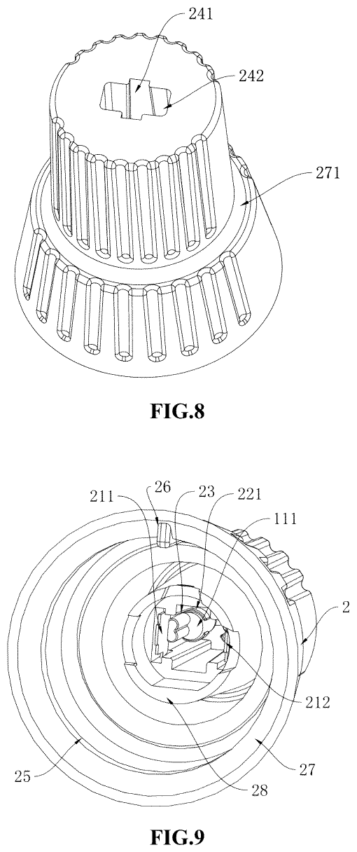

In some embodiments, at least one snap-fit protrusion 362 is arranged on the connection cap 36 (FIG. 3), and snap-fit groove 25 arranged along the circumferential direction of the lamp interface 2 is arranged on an inner wall of the lamp interface 2 in a region corresponding to the snap-fit protrusion 362 (FIG. 9). The snap-fit protrusion 362 is provided a guide surface 3621 that is gradually inclined toward the central axis of the connection cap 36 in a direction away from the lampshade 33. Thus, it facilitates inserting the plug-in connector 31 into the lamp interface 2. The cooperation between the snap-fit protrusion 362 and the snap-fit groove 25 not only makes it convenient to apply force when clamping the plug-in connector 31 and the lamp interface 2, but also ensures a stable connection after clamping.

In some embodiments, the inner wall of the lamp interface 2 is further provided with a guide rim 26 protruding towards the central axis of the lamp interface 2, the guide rim 28 being arranged in a direction of mutual plugging of the plug-in connector 31 and the lamp interface 2, (e.g., in the axial direction of the lamp interface 2). Correspondingly, a guide groove 363 capable of matching with the guide rim 26 is arranged on the outer surface of the connecting cap 36. Thus, the angle and direction at which the plug-in connector 31 is fitted into the lamp interface 2 can be defined by the cooperation of the guide rim 26 and the guide groove 363, thereby ensuring sufficient electrical connection of the light-emitting element 32 with the wire portion 1 after the plug-in connector 31 is inserted into position.

In some embodiments, the lamp interface 2 includes an outer interface 27, and the outer interface 27 is provided with a bent region that shrinks toward the central axis of the outer interface 27, the bent region being mutually abuttable with a surface of the connection cap 36 away from the light-emitting element 32. It can thus be ensured that the lamp interface 2 and the plug-in connector 31 can be snapped into place with a stable fit.

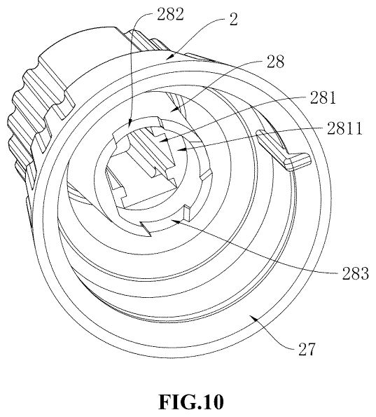

As shown in FIG. 10, in some embodiments, an inner interface 28 is arranged inside the outer interface 27, the inner interface 28 is provided with two inner abutting walls facing the first conductive plate 211 and the second conductive plate 212, the two inner abutting walls 281 are arranged opposite to the first limiting sidewall 3511 and the second limiting sidewall 3521, after the plug-in connector is inserted into the lamp interface 2, the inner abutting walls 281 are capable of abutting the first conductive plate 211 and the second conductive plate 212 against the first limiting sidewall 3511 and second limiting sidewall 3521, respectively. A first stepped surface 37 that protrudes outward away from the central axis of the plug-in connector 31 is provided on the side, close to the light-emitting element 32, of the first limiting sidewall 3511 or the second limiting sidewall 3521 of the plug-in connector 31. Correspondingly, a second stepped surface 2811 capable of cooperating with the first stepped surface 37 is provided on an end of the inner abutting wall 281 close to the light-emitting element 32. Thus, after the plug-in connector 31 is inserted into the lamp interface 2, the first stepped surface 37 and the second stepped surface 2811 can abut against each other in partial regions. Together with the inner abutting walls 281 and the limiting sidewalls 3511 and 3521, they jointly form an accommodating space. This space ensures that the first conductive member 311 and the first conductive plate 211 abut against each other and achieve electrical connection, and the second conductive member 212 and the second conductive plate 212 abut against each other and achieve electrical connection.

In some embodiments, the surface of the connection cap 36 away from the light-emitting element 32 is further provided with at least one first limiting protrusion 364 matching with the inner interface 28 and at least one second limiting protrusion 365 matching with the inner interface 28 (FIGS. 2 and 6). The first limiting protrusion 364 and the second limiting protrusion 365 each protrude away from the upper surface of the connection cap 36, and extend in a direction away from the central axis of the plug-in connector 31, the first limiting protrusion 364 extending a greater distance than the second limiting protrusion 365 in the direction away from the central axis of the plug-in connector 31, and the first limiting protrusion 364 also having a greater height than the second limiting protrusion 365 when protruding away from the connection cap 36. Accordingly, a first notch 282 and a second notch 2 283 are provided in the inner interface 28 corresponding to the first limiting protrusion 364 and the second limiting protrusion 365, respectively, the first limiting protrusion 364 being receivable into the first notch 282 and the second limiting protrusion 365 being receivable into the second notch 283. The notch edge of the first notch 282 is located on a side further away from the light-emitting element 32 than the notch edge of the second notch 283. Thus, the lengths of the regions of the inner interface 28 corresponding to the first notch 282 and the second notch 283 that extend toward the light-emitting element 32 form a staggered effect, and accordingly a more stable connection effect with the plug-in connector 31 is formed.

In some embodiments, the connection end isolation region 3132, the conductive member isolation region 3131, and the connection cap 36 form an integral component.

The above embodiments are merely illustrative of the technical concepts and features of the present disclosure, and are intended to enable those skilled in the art to understand and practice the present disclosure, and should not be construed as limiting the scope of the present disclosure. Equivalent variations and modifications according to the spirit of the present disclosure are intended to be included within the scope of the present disclosure.

What is claimed is:

1. A light string, comprising a wire portion and a plurality of lamp interfaces sequentially and electrically connected in series with the wire portion, wherein the light string further comprises light-emitting portions pluggably connected with the lamp interfaces,
the light-emitting portion comprises a light-emitting element, a lampshade located outside the light-emitting element, and a plug-in connector connected with the lampshade, wherein the plug-in connector is provided with a first conductive member and a second conductive member, the first conductive member and the second conductive member being capable of electrically connecting the light-emitting element with the wire portion when the plug-in connector is inserted into the lamp interface.

2. The light string according to claim 1, wherein a first conductive plate and a second conductive plate are arranged inside the lamp interface, and the first conductive plate is capable of abutting against the first conductive member to achieve electrical connection, the second conductive plate is capable of abutting against the second conductive member to achieve electrical connection when the plug-in connector is inserted into the lamp interface.

3. The light string according to claim 2, wherein the plug-in connector further comprises an electrical isolation portion, and the electrical isolation portion comprises a conductive member isolation region for isolating the first conductive member and the second conductive member from each other.

4. The light string according to claim 3, wherein a first cavity and a second cavity for allowing the first conductive member and the second conductive member to pass through are respectively arranged on two opposite outer sides of the conductive member isolation region, and outer sidewalls of the first cavity and the second cavity, away from the conductive member isolation region, are a first limiting sidewall and a second limiting sidewall, respectively, the first limiting sidewall and the second limiting sidewall being gradually inclined away from the conductive member isolation region along a direction towards the light-emitting element.

5. The light string according to claim 4, wherein a distance between the surface of the end, close to the light-emitting element, of the first conductive plate, which is close to the first limiting sidewall and the first limiting sidewall is smaller than the diameter of a tail end of the first conductive member; and a distance between the surface of the end, close to the light-emitting element, of the second conductive plate, which is close to the second limiting sidewall and the second limiting sidewall is smaller than the diameter of a tail end of the second conductive member.

6. The light string according to claim 3, wherein a notch portion is arranged on the wire portion at a region corresponding to the lamp interface, and the wire portion forms two wire ends at the notch portion for electrical connection with the light-emitting element, the two wire ends being electrically connected with the first conductive plate and the second conductive plate respectively.

7. The light string according to claim 6, wherein a first connection end and a second connection end are respectively arranged on wire protective layers at tail ends of the two wire ends, the first connection end is connected with the first conductive plate through a wire clamping member and the second connection end is connected with the second conductive plate through the wire clamping member, so that internal conductors of the wire ends exposed outside the protective layers are bound by the wire clamping members, and the tail ends of the internal conductors are brought into contact with the first conductive plate and the second conductive plate respectively.

8. The light string according to claim 7, wherein the electrical isolation portion further comprises a connection end isolation region for isolating the first connection end and the second connection end from each other.

9. The light string according to claim 8, wherein the side of the connection end isolation region close to the wire end to which the notch portion corresponds is provided with a limiting groove (31321 recessed away from the wire portion.

10. The light string according to claim 4, wherein the plug-in connector further comprises a connection cap arranged close to the lampshade, an installation opening for installing the light-emitting element is arranged in the connection cap, the first cavity and the second cavity communicate with the installation opening, the first conductive member passes through the first cavity to connect with the light-emitting element, and the second conductive member passes through the second cavity to connect with the light-emitting element.

11. The light string according to claim 10, wherein at least one snap-fit protrusion is arranged on the connection cap, a snap-fit groove arranged along the circumferential direction of the lamp interface is arranged on an inner wall of the lamp interface in a region corresponding to the snap-fit protrusion, and the snap-fit protrusion is provided a guide surface that is gradually inclined toward the central axis of the connection cap in a direction away from the lampshade.

12. The light string according to claim 10, wherein the lamp interface comprises an outer interface provided with a bent region that shrinks toward the central axis of the outer interface, the bent region being mutually abuttable with a surface of the connection cap away from the light-emitting element.

13. The light string according to claim 12, wherein the lamp interface further comprises an inner interface arranged inside the outer interface, the inner interface is provided with inner abutting walls facing the first conductive plate and the second conductive plate, the inner abutting walls are arranged opposite to the first limiting sidewall and the second limiting sidewall, after the plug-in connector is inserted into the lamp interface, the inner abutting walls are capable of abutting the first conductive plate and the second conductive plate against the first limiting sidewall and second limiting sidewall, respectively, a first stepped surface that protrudes outward away from the central axis of the plug-in connector is provided on the side, close to the light-emitting element, of the first limiting sidewall and the second limiting sidewall of the plug-in connector, and a second stepped surface capable of cooperating with the first stepped surface is provided on an end of the inner abutting wall close to the light-emitting element.

14. The light string according to claim 13, wherein the surface of the connection cap away from the light-emitting element is further provided with at least one first limiting protrusion matching with the inner interface and at least one second limiting protrusion matching with the inner interface.

15. The light string according to claim 14, wherein the first limiting protrusion and the second limiting protrusion each protrude away from the upper surface of the connection cap, and extend in a direction away from the central axis of the plug-in connector, the first limiting protrusion extending a greater distance than the second limiting protrusion in the direction away from the central axis of the plug-in connector, and the first limiting protrusion also having a greater height than the second limiting protrusion when protruding away from the connection cap.

16. The light string according to claim 10, wherein the inner wall of the lamp interface is further provided with a guide rim protruding towards the central axis of the lamp interface, the guide rim being arranged in a direction of mutual plugging of the plug-in connector and the lamp interface, and a guide groove capable of matching with the guide rim is arranged on the outer surface of the connection cap.

17. The light string according to claim 6, wherein a first groove for the plug-in connector to snap into is provided on the surface of the lamp interface that is away from the light-emitting element, a second groove that is arranged perpendicularly to and in communication with the first groove is further comprised, the second groove being arranged along the length direction of the light string, and the two wire ends corresponding to the notch portion are respectively arranged at the mutually distant ends of the second groove.

18. The light string according to claim 1, wherein a male joint and a female joint are provided at a head end and a tail end of the light string, respectively.

19. The light string according to claim 1, wherein the shape of the light-emitting element is selected from at least one of the following shapes: inverted triangle, V-shape or W-shape.

20. The light string according to claim 1, wherein the light-emitting element is a PCB-based light-emitting element, a plurality of parallel LED beads are arranged on the light-emitting element, and positive and negative electrodes of any two adjacent beads are arranged in a staggered manner.
